(19) United States
(12) Patent Application Publication
(10) Pub. No.: US 2005/0011106 A1
(43) Pub. Date: Jan. 20, 2005

(54) Fishing reel display and mounting apparatus

(76) Inventor: Gerard T. Sindone, Oceanside, NY (US)

Correspondence Address: Fitzpatrick Cella, Harper & Scinto, 30 Rockefeller Plaza, New York,, NY, 10112-3800, US

(21) Appl. No.: 10/618,798

(22) Filed: Jul. 14, 2003

(51) Int. Cl. A01K 87/06

(52) U.S. Cl. 43/22

(57) ABSTRACT

The present invention relates to a fishing reel display and mounting apparatus having a central support rod and vertically spaced mounting rings affixed thereto. The rings are of a greater diameter then the central support rod to provide a space therebetween to accommodate the mounting flange of the conventional fishing reel for display and inspection.

### BACKGROUND AND SUMMARY OF THE INVENTION

The present invention relates to a fishing reel display apparatus and more particularly to a device for mounting and displaying fishing reels. Conventionally, fishing reels are simply displayed in their shipping boxes separately in display cases or on an associated fishing rod. These display arrangements have disadvantages in that the reels have to be removed from their shipping containers display cases or dismounted from their associated rods for the potential purchaser to inspect. The present invention avoids the problem associated with prior display and mounting devices, providing a display device which mounts and displays a plurality of individual reels readily available for inspection by potential purchasers.

An elongated central support rod is provided with a number of spaced outer mounting rings of greater diameter then the central support rod. The outer mounting rings are fixed to the central support rod at vertically-spaced locations with the outer surface of the central support rod spaced from the inner surface of the outer mounting rings. The space between the central support rod and the outer mounting rings removably accommodates the metal mounting flange of the conventional fishing reel with the body of the reel displayed outwardly of the mounting device for ready inspection.

### BRIEF DESCRIPTION OF THE DRAWINGS

FIG. 1 is a partial front view of the mounting device of the invention with fish reels mounted thereon

FIG. 2 is a partial view of the mounting device including the central support rod and mounting rings

FIG. 3 is a cross-sectional view of the central support rod and mounting rings

### DETAILED DESCRIPTION

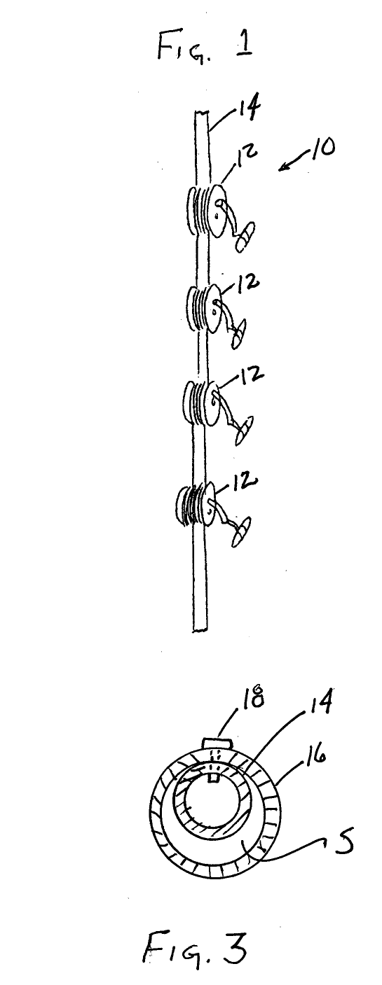

FIG. 1 illustrates the mounting device 10 of the present invention with fishing reels 12 mounted thereon. As shown in FIG. 1, the fishing reels 12 are mounted at vertically-spaced locations on the mounting device 10. Mounting device 10 comprise a vertically-disposed central support rod 14 which is preferably of a hollow tube configuration although a solid tube can be employed. Mounting rings 16 of a slightly larger inner diameter then the outer diameter of central support rod 14 are fixed to rod 14 at vertically spaced locations by any suitable means such as screws 18 or by adhesive. It will be understood that rod 14 and rings 16 may be of a square, rectangular, elliptical or other accommodating configuration.

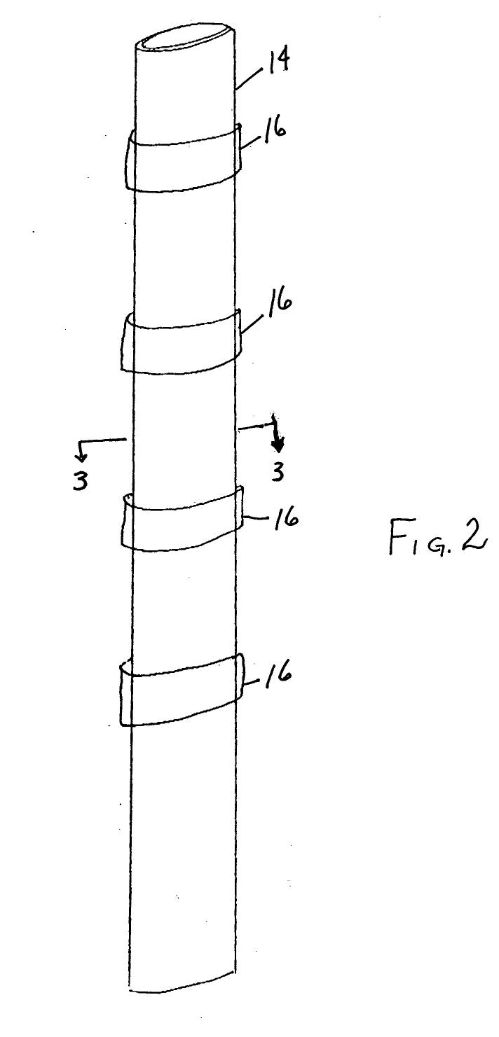

As shown best in FIG. 3, rings 16 are fixed to central support rod 14 and dimensioned to provide spaces between the outer surface of rod 14 and the inner surface of rings 16. Space S accomodates the metal mounting flange of the conventional fishing reel with the reel body positioned outward of the support rod 14 as shown in FIG. 1. The present invention thus comprises a fishing reel mounting device that saves valuable storage space and displays the fishing reel for easy access and inspection.

1. (cancelled).

2. A fishing reel mounting and display device adapted to mount fishing reels having rod mounting flanges affixed thereto comprising an elongated support member, a plurality of hollow reel mounting members, said reel mounting members having an inner open area greater than the outer surface of the elongated support member, means mounting the elongated support member within the reel mounting members and securing said reel mounting members in stationary position at fixed spaced locations along the length of said support member the reel mounting members and the elongated support member adapted to accommodate the rod mounting flanges of a plurality of fishing reels in the space between the stationary reel mounting members and the elongated support member for display of the reels outwardly from the elongated support member.

3. A fishing reel mounting and display device adapted to mount fishing reels having rod mounting flanges affixed thereto comprising an elongated, vertical, generally-circular, rigid support member, a plurality of generally-circular hollow reel mounting members, said reel mounting members having an inner diameter greater than the outer diameter of the elongated support member, means mounting the elongated support member within the reel mounting members and securing said reel mounting members in stationary position at fixed spaced locations along the length of said support member the reel mounting members and the elongated support member adapted to accommodate the rod mounting flanges of a plurality of fishing reels in the space between the stationary reel mounting members and the elongated support member for display of the reels outwardly from the elongated support member.
